(19) United States
(12) Patent Application Publication
(10) Pub. No.: US 2025/0294478 A1
(43) Pub. Date: Sep. 18, 2025

(54) POWER CONTROL WITH NETWORK-CONTROLLED REPEATERS

(71) Applicant: Lenovo (Singapore) Pte. Limited, Singapore (SG)

(72) Inventors: Majid Ghanbarinejad, Lake Forest, CA (US); Ali Ramadan Ali, Kraiburg (DE); Vijay Nangia, Woodridge, IL (US); Ahmed Hindy, Aurora, IL (US)

(73) Assignee: Lenovo (Singapore) Pte. Limited, Singapore (SG)

(21) Appl. No.: 18/860,268

(22) PCT Filed: Apr. 25, 2023
(86) PCT No.: PCT/IB2023/054239

§ 371 Date: Oct. 25, 2024

Related U.S. Application Data
(60) Provisional application No. 63/335,704, filed on Apr. 27, 2022.

(51) Int. Cl. H04W 52/36; H04W 16/28; H04W 52/32; H04W 52/42

(52) U.S. Cl. CPC H04W 52/367; H04W 16/28; H04W 52/325; H04W 52/42

(57) ABSTRACT

Various aspects of the present disclosure relate to an NCR that receives, from a base station, an indication of a power offset value or a power adjustment value associated with one or more beam indicators. The NCR receives a signal from the base station, and determines whether a beam indicator that is to be applied to forward the signal is included in the one or more beam indicators. The NCR, based on the beam indicator being included in the one or more beam indicators, transmits the signal to a user equipment with the power offset value applied to adjust a reference transmission power, or with the power adjustment value applied to adjust a previous transmission power.

### RELATED APPLICATION

This application claims priority to U.S. Provisional Application Ser. No. 63/335,704 filed Apr. 27, 2022 entitled “Power Control with Network-Controlled Repeaters,” the disclosure of which is incorporated by reference herein in its entirety.

### TECHNICAL FIELD

The present disclosure relates to wireless communications, and more specifically to network-controlled repeaters (NCRs).

### BACKGROUND

A wireless communications system may include one or multiple network communication devices, such as base stations, which may be otherwise known as an eNodeB (eNB), a next-generation NodeB (gNB), core network functions (CNFs), or other suitable terminology. Each network communication device, such as a base station, may support wireless communications for one or multiple user communication devices, which may be otherwise known as user equipment (UE), or other suitable terminology. The wireless communications system may support wireless communications with one or multiple user communication devices by utilizing resources of the wireless communication system, such as time resources (e.g., symbols, slots, subslots, mini-slots, aggregated slots, subframes, frames, or the like) or frequency resources (e.g., subcarriers, carriers). Additionally, the wireless communications system may support wireless communications across various radio access technologies (RATs) including third generation (3G) RAT, fourth generation (4G) RAT, fifth generation (5G) RAT, and other suitable RATs beyond 5G. In some cases, a wireless communications system may be a non-terrestrial network (NTN), which may support various communication devices for wireless communications in the NTN. For example, an NTN may include network entities onboard non-terrestrial vehicles such as satellites, unmanned aerial vehicles (UAV), and high-altitude platforms systems (HAPS), as well as network entities on the ground, such as gateway entities capable of transmitting and receiving over long distances.

A wireless communications system may include one or more wireless repeaters that receive and retransmit signals (e.g., from a base station or a UE). A wireless repeater extends the footprint or layout of cells in a cellular system for improving key performance indicators such as throughput and coverage. As a result, wireless repeaters may extend the cells beyond their originally planned boundaries. A network-controlled repeater (NCR) is essentially an analog repeater that is augmented with a side-control channel through which the NCR can receive control signals from a serving base station (BS, gNB) and apply information obtained from the control signals for beamforming, determining a direction of communication (downlink versus uplink), turning the analog relaying on and off, and so on.

### SUMMARY

The present disclosure relates to methods, apparatuses, and systems that support power control with NCRs. By utilizing the described techniques, power control is utilized for interference management of NCRs. Aspects of the disclosure are directed to techniques in which an NCR receives a configuration and/or signaling from a base station, where the configuration and/or signaling includes an indication to apply a power offset and/or adjustment in an amplify-and-forward operation associated with one or multiple beams or spatial directions. In one or more implementations, the power offset and/or adjustment is associated with a frequency, time duration, channel, reference signal, or the like. In response, the NCR applies the power offset and/or adjustment when forwarding signals based on determining that the signals are associated with the indicated beams, spatial directions, frequency/time resources, channels, and/or reference signals.

Some implementations of the method and apparatuses described herein may include wireless communication at a device (e.g., an NCR), and the device receives, from a base station, an indication of a power offset value or a power adjustment value associated with one or more spatial filters. The NCR receives a signal from the base station, and determines whether a spatial filter that is to be applied to forward the signal is included in the one or more spatial filters. The NCR, based on the spatial filter being included in the one or more spatial filters, transmits the signal to a user equipment with the power offset value applied to adjust a reference transmission power, or with the power adjustment value applied to adjust a previous transmission power.

In some implementations of the method and apparatuses described herein, a NCR receives, from a base station, a first message indicating a power offset value associated with one or more beam indicators. The NCR receives a first signal from the base station, and determines whether a beam indicator that is to be applied to forward the first signal is included in the one or more beam indicators. Based at least in part on the beam indicator being included in the one or more beam indicators, the NCR transmits the first signal to a user equipment with the power offset value applied to adjust a reference transmission power.

Some implementations of the method and apparatuses described herein may further include the first message indicates that the power offset value includes at least one of a radio resource control (RRC) configuration, a downlink control information (DCI) message, or a medium access control (MAC) control element (CE) message. The power offset value is indicated in decibels. Each of the one or more beam indicators are indicated by a reference to a downlink reference signal, and wherein the downlink reference signal is at least one of a synchronization signal and physical broadcast channel (SS/PBCH) block, or a channel state information reference signal (CSI-RS). Each of the one or more beam indicators are indicated by at least one of a spatial direction or a spatial filter. Each of the one or more beam indicators are indicated by an uplink reference signal, and the uplink reference signal is a sounding reference signal (SRS). The NCR receives a second message indicating the beam indicator that is to be applied to forward the second signal. The NCR receives a second message indicating the user equipment and determine the beam indicator that is to be applied to forward the first signal is associated with the user equipment. The NCR determines the reference transmission power based in part on at least one of a capability of the apparatus, a configuration of the apparatus, the configuration from the base station, or a regional regulation. The reference transmission power is at least one of a default transmission power, or a maximum transmission power associated with a cell provided by the base station.

Additionally, the power offset value is further associated with a frequency range, and the power offset value is further applied based at least in part on a determination that the first signal is in the frequency range. The power offset value is further associated with a time duration, and the power offset value is further applied based at least in part on a determination that the first signal is received during the time duration. The power offset value is further associated with at least one of a channel, a channel type, a reference signal, or a reference signal type; and the power offset value is further applied based at least in part on a determination that the first signal is associated with at least one of the channel, the channel type, the reference signal, or the reference signal type. The NCR determines that the first message is associated with a collocated wireless device.

In some implementations of the method and apparatuses described herein, a NCR receives, from a base station, a message indicating a power adjustment value associated with one or more beam indicators. The NCR receives a signal from the base station, and determines whether a beam indicator that is to be applied to forward the signal is included in the one or more beam indicators. Based at least in part on the beam indicator being included in the one or more beam indicators, The NCR transmits the signal to a user equipment with the power adjustment value applied to adjust a previous transmission power.

Some implementations of the method and apparatuses described herein may further include the power adjustment value is further associated with a frequency range, and the previous transmission power is associated with the frequency range. The power adjustment value is further associated with a time duration, and the previous transmission power is associated with the time duration. The power adjustment value is further associated with at least one of a channel, a channel type, a reference signal, or a reference signal type; and the previous transmission power is associated with the at least one of the channel, the channel type, the reference signal, or the reference signal type.

### BRIEF DESCRIPTION OF THE DRAWINGS

Various aspects of the present disclosure for power control with a network-controlled repeater are described with reference to the following Figures. The same numbers may be used throughout to reference like features and components shown in the Figures.

FIG. 1 illustrates an example of a wireless communications system that supports power control with NCRs in accordance with aspects of the present disclosure.

FIG. 2 illustrates an example of inter-cell interference as related to power control with NCRs in accordance with aspects of the present disclosure.

FIG. 3 illustrates an example of increased inter-cell interference due to NCRs, as related to power control with NCRs in accordance with aspects of the present disclosure.

FIGS. 4A-4B illustrate an example of the ASN. 1 code for IE definitions related to the position of a TRP in NR positioning protocol A (NRPPa) as related to power control with NCRs in accordance with aspects of the present disclosure.

FIG. 5 illustrates an example of reducing inter-cell interference by spatially associated power offset, as related to power control with NCRs in accordance with aspects of the present disclosure.

FIG. 6 illustrates an example block diagram of components of a device (e.g., an NCR) that supports power control with a NCRs in accordance with aspects of the present disclosure.

FIG. 7 illustrates an example block diagram of components of a device (e.g., a base station, UE, wireless device, network device) that supports power control with NCRs in accordance with aspects of the present disclosure.

FIGS. 8 and 9 illustrate flowcharts of methods that support power control with NCRs in accordance with aspects of the present disclosure.

### DETAILED DESCRIPTION

Implementations of power control with a network-controlled repeater are described, such as related to power control for interference management. An aspect of NCR side control is information to be conveyed to the NCR, and how this side control information is applied by the NCR. Considerations include using the side control to convey information of beamforming, TDD (UL/DL), and on/off switching. Related objectives include to identify which side control information is necessary for network-controlled repeaters, including assumption of max transmission power. The side control information may include beamforming information; timing information to align transmission/reception boundaries of a network-controlled repeater; information on UL-DL TDD configuration; ON-OFF information for efficient interference management and improved energy efficiency; and power control information for efficient interference management (as the 2nd priority). Additionally, L1/L2 signaling (including its configuration) is identified to carry the side control information.

Aspects of the disclosure are directed to techniques in which an NCR receives a configuration and/or signaling from a base station, where the configuration and/or signaling includes an indication to apply a power offset and/or adjustment in an amplify-and-forward operation associated with one or multiple beams or spatial directions. In one or more implementations, the power offset and/or adjustment is associated with a frequency, time duration, channel, reference signal, or the like. In response, the NCR applies the power offset and/or adjustment when forwarding signals based on determining that the signals are associated with the indicated beams, spatial directions, frequency/time resources, channels, and/or reference signals.

Aspects of the present disclosure are described in the context of a wireless communications system. Aspects of the present disclosure are further illustrated and described with reference to device diagrams and flowcharts that relate to power control with NCRs.

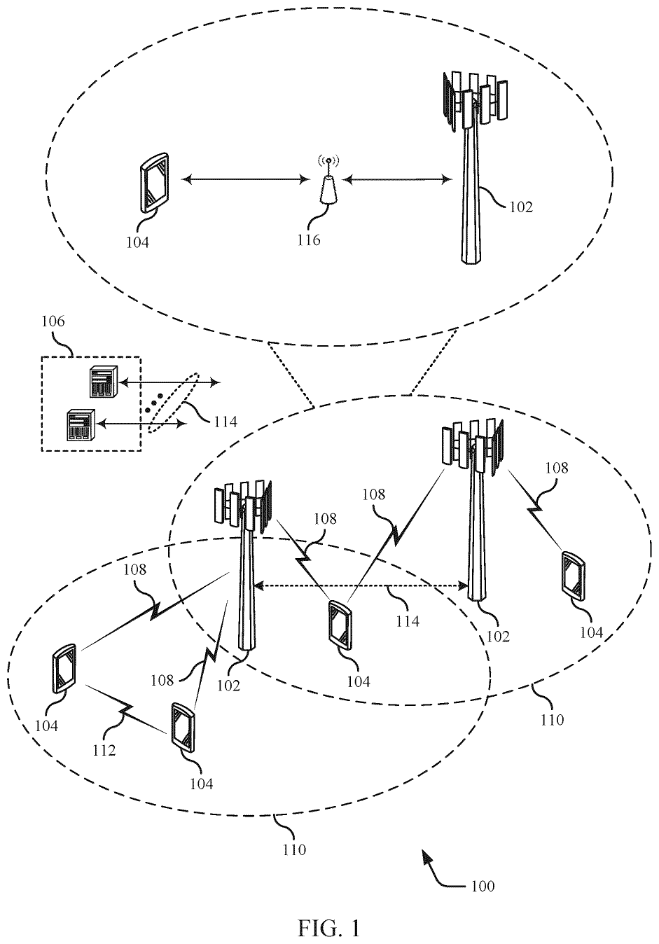

FIG. 1 illustrates an example of a wireless communications system 100 that supports power control with NCRs in accordance with aspects of the present disclosure. The wireless communications system 100 may include one or more base stations 102, one or more UEs 104, and a core network 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as a NR network. In other implementations, the wireless communications system 100 may be a combination of a 4G network and a 5G network. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more base stations 102 may be dispersed throughout a geographic region to form the wireless communications system 100. One or more of the base stations 102 described herein may be, or include, or may be referred to as a base transceiver station, an access point, a NodeB, an eNodeB (eNB), a next-generation NodeB (gNB), a Radio Head (RH), a relay node, an integrated access and backhaul (IAB) node, or other suitable terminology. A base station 102 and a UE 104 may communicate via a communication link 108, which may be a wireless or wired connection. For example, a base station 102 and a UE 104 may perform wireless communication over a NR-Uu interface.

A base station 102 may provide a geographic coverage area 110 for which the base station 102 may support services (e.g., voice, video, packet data, messaging, broadcast, etc.) for one or more UEs 104 within the geographic coverage area. For example, a base station 102 and a UE 104 may support wireless communication of signals related to services (e.g., voice, video, packet data, messaging, broadcast, etc.) according to one or multiple radio access technologies. In some implementations, a base station 102 may be moveable, such as when implemented as a gNB onboard a satellite or other non-terrestrial station (NTS) associated with a non-terrestrial network (NTN). In some implementations, different geographic coverage areas 110 associated with the same or different radio access technologies may overlap, and different geographic coverage areas 110 may be associated with different base stations 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region or coverage area 110 of the wireless communications system 100. A UE 104 may include or may be referred to as a mobile device, a wireless device, a remote device, a handheld device, a customer premise equipment (CPE), a subscriber device, or as some other suitable terminology. In some implementations, the UE 104 may be referred to as a unit, a station, a terminal, or a client, among other examples. Additionally, or alternatively, a UE 104 may be referred to as an Internet-of-Things (IoT) device, an Internet-of-Everything (IoE) device, or as a machine-type communication (MTC) device, among other examples. In some implementations, a UE 104 may be stationary in the wireless communications system 100. In other implementations, a UE 104 may be mobile in the wireless communications system 100, such as an earth station in motion (ESIM).

The one or more UEs 104 may be devices in different forms or having different capabilities. Some examples of UEs 104 are illustrated in FIG. 1. A UE 104 may be capable of communicating with various types of devices, such as the base stations 102, other UEs 104, or network equipment (e.g., the core network 106, a relay device, a gateway device, an integrated access and backhaul (IAB) node, a location server that implements the location management function (LMF), or other network equipment). Additionally, or alternatively, a UE 104 may support communication with other base stations 102 or UEs 104, which may act as relays in the wireless communications system 100.

A UE 104 may also support wireless communication directly with other UEs 104 over a communication link 112. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 112 may be referred to as a sidelink. For example, a UE 104 may support wireless communication directly with another UE 104 over a PC5 interface.

A base station 102 may support communications with the core network 106, or with another base station 102, or both. For example, a base station 102 may interface with the core network 106 through one or more backhaul links 114 (e.g., via an S1, N2, or other network interface). The base stations 102 may communicate with each other over the backhaul links 118 (e.g., via an X2, Xn, or another network interface). In some implementations, the base stations 102 may communicate with each other directly (e.g., between the base stations 102). In some other implementations, the base stations 102 may communicate with each other indirectly (e.g., via the core network 106). In some implementations, one or more base stations 102 may include subcomponents, such as an access network entity, which may be an example of an access node controller (ANC). The ANC may communicate with the one or more UEs 104 through one or more other access network transmission entities, which may be referred to as remote radio heads, smart radio heads, gateways, transmission-reception points (TRPs), and other network nodes and/or entities.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)), and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management for the one or more UEs 104 served by the one or more base stations 102 associated with the core network 106.

According to one or more implementations, the wireless communications system 100 includes a wireless repeater that is an NCR, illustrated as NCR 116. It is to be appreciated that the wireless system 100 can include any number of NCRs 116. A base station 102 transmits and receives signals within a particular geographical distance or range, referred to as a cell. This distance or range, and thus the cell, can be extended using one or more NCRs. One or more of the NCRs 116 and base stations 102 are operable to implement various aspects of power control with NCRs, as described herein. An NCR, also referred to as a smart repeater, is a repeater controlled by the network (e.g., a base station 102). For instance, in one or more implementations the NCR 116 is an analog repeater that is augmented with a side-control channel through which the NCR 116 can receive control signals from a serving base station 102 (e.g., gNB) and apply information obtained from the control signals for beamforming, determining a direction of communication (downlink versus uplink), turning the analog relaying on and off, and so on. Multiple base stations 102 may also communicate with each other over the backhaul links 114 (e.g., via an X2, Xn, or another network interface) to exchange information associated with the wireless system 100 configuration and control signaling, and coordinate for interference management.

This disclosure addresses power control for interference management, and includes figures that illustrate an example of how cell extension by using NCRs may contribute to inter-cell interference (ICI) and cross-link interference (CLI) in nearby cells.

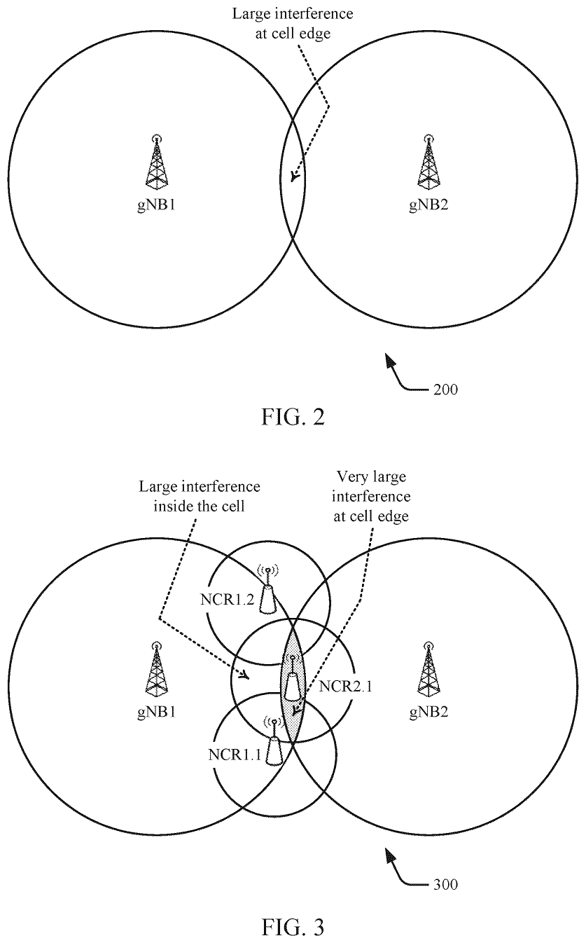

FIG. 2 illustrates an example 200 of inter-cell interference as related to power control with NCRs. The example 200 illustrates two cells in a vicinity operating at a same frequency f1. By proper cell planning, interference may be contained in most of the cells' coverage areas.

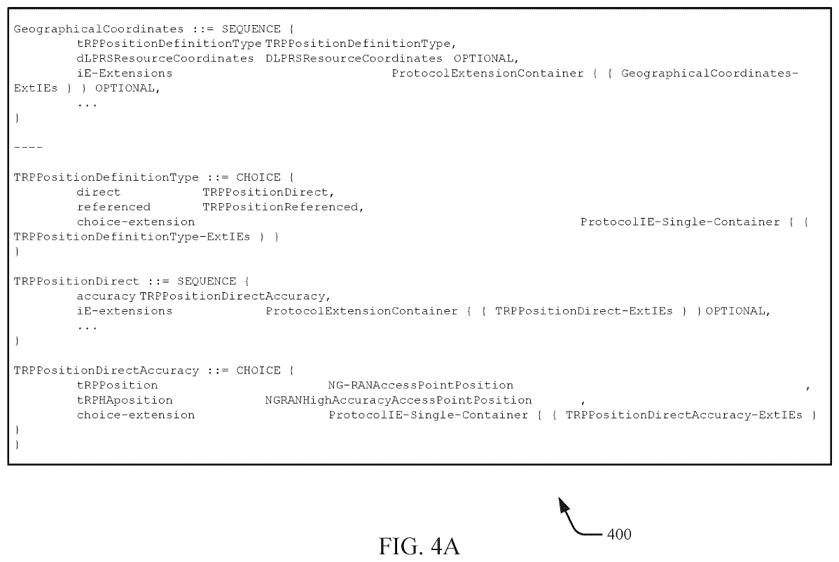

FIG. 3 illustrates an example 300 of increased inter-cell interference due to network-controlled repeaters, as related to power control with NCRs. As illustrated, the repeaters (NCRs) alter the cell footprint and aim to improve coverage and performance for coverage holes. However, without proper frequency planning, this may also increase interference on nearby cells, especially at cell edges of the neighboring cells where the direct signal from the neighboring gNB is relatively weak. In this present disclosure, techniques are provided for power control with network-controlled analog repeaters with a focus on interference management through power control.

With respect to SID on an NCR, coverage is a fundamental aspect of cellular network deployments. Mobile operators rely on different types of network nodes to offer blanket coverage in their deployments. Deployment of regular full-stack cells is one option, but it may not always be possible (e.g., no availability of backhaul) or economically viable. As a result, new types of network nodes are considered to increase mobile operators' flexibility for network deployments. For example, Integrated Access and Backhaul (IAB) was introduced and enhanced as a new type of network node not requiring a wired backhaul. Another type of network node is the RF repeater, which simply amplifies-and-forwards any signal that is received. The RF repeaters have seen a wide range of deployments in 2G, 3G, and 4G to supplement the coverage provided by regular full-stack cells, and RF and EMC requirements have been specified for such RF repeaters for NR targeting both FR1 and FR2.

While an RF repeater presents a cost effective means of extending network coverage, it has its limitations. An RF repeater simply performs an amplify-and-forward operation without being able to take into account various factors that could improve performance. Such factors may include information on semi-static and/or dynamic downlink/uplink configuration, adaptive transmitter/receiver spatial beamforming, ON-OFF status, etc. An NCR is an enhancement over conventional RF repeaters with the capability to receive and process side control information from the network. Side control information could allow a network-controlled repeater to perform an amplify-and-forward operation in a more efficient manner. Potential benefits may include mitigation of unnecessary noise amplification, transmissions and receptions with better spatial directivity, and simplified network integration.

An aspect of NR NCRs focuses on several scenarios and assumptions, including NCRs are inband RF repeaters used for extension of network coverage on FR1 and FR2 bands, while FR2 deployments may be prioritized for both outdoor and O2I scenarios; for only single hop stationary network-controlled repeaters; NCRs are transparent to UEs; and NCRs can maintain the gNB-repeater link and repeater-UE link simultaneously. Notably, cost efficiency is a consideration point for network-controlled repeaters.

Related objectives include to identify which side control information is necessary for network-controlled repeaters, including assumption of max transmission power. The side control information may include beamforming information; timing information to align transmission/reception boundaries of a network-controlled repeater; information on UL-DL TDD configuration; ON-OFF information for efficient interference management and improved energy efficiency; and power control information for efficient interference management (as the 2nd priority). Additionally, L1/L2 signaling (including its configuration) is identified to carry the side control information. Further, aspects of NCR management include identification and authorization of NCRs, and coordination with SA3 may be needed.

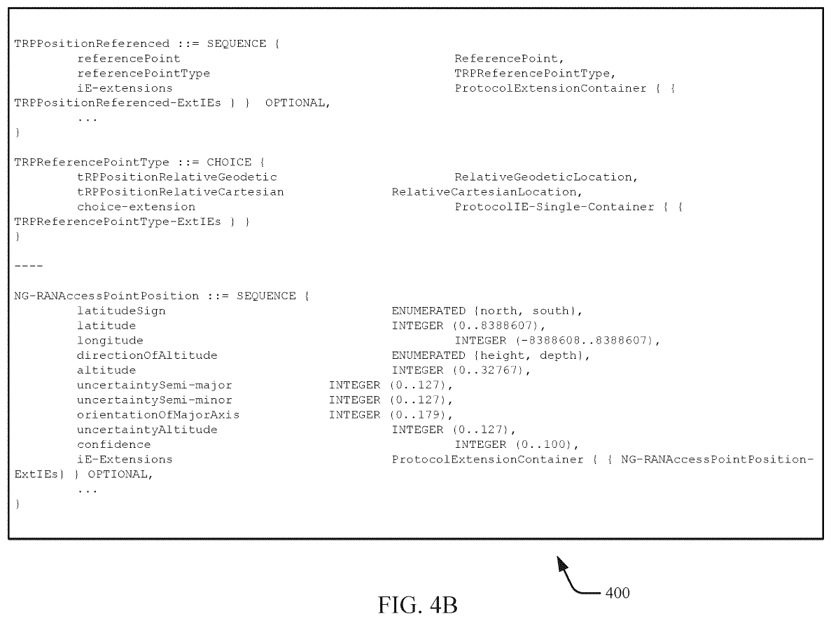

FIGS. 4A-4B illustrate an example 400 of the ASN.1 code for IE definitions related to the position of a TRP in NR positioning protocol A (NRPPa) as related to power control with NCRs.

In aspects of power control with NCRs, techniques are proposed in this disclosure according to which an NCR receives a configuration and/or control signaling from the network, for example a serving gNB, where the configuration and/or control signaling includes an indication to apply a power offset in an amplify-and-forward operation associated with one or multiple beams or spatial directions. Furthermore, techniques are described with respect to an NCR receives an indication to reduce or adjust a transmission power associated with one or multiple beams or spatial directions. In implementations, the power offset and/or adjustment is associated with a frequency, time duration, channel, reference signal, or the like. In response to receiving the indication, the NCR applies the power offset and/or adjustment when forwarding signals based on determining that the signals are associated with the beams, spatial directions, frequency/time resources, channels, and/or reference signals. An application of the proposed techniques is controlling interference caused by the signals forwarded by the network-controlled repeaters on other devices, such as devices in other cells in the vicinity.

In an implementation for power offset, an NCR may receive a configuration and/or signaling from the network, where the configuration and/or signaling may include an indication to apply a power offset associated with one or multiple beams. The power offset may be indicated by an offset value with respect to a baseline or default value (e.g., in units of decibels (dB)). In an implementation, a beam may be indicated by a reference to a downlink reference signal, such as a synchronization signal and physical broadcast channel (SS/PBCH) block, a channel state information reference signal (CSI-RS), or other downlink reference signals. The indication may include a reference signal (RS) identifier (ID), a quasi-collocation (QCL) relationship such as a QCL Type D with the reference signal as a source, a transmission configuration indication (TCI) comprising a QCL relationship, and the like. In response to receiving the configuration and/or signaling, the NCR may apply the power offset when forwarding the indicated reference signal. Additionally or alternatively, the NCR may apply the power offset when forwarding a downlink signal (e.g., a signal can comprise at least a reference signal and/or a channel) based on determining that a beam associated with the indicated reference signal is applied for the forwarding.

In another implementation, a beam may be indicated by a reference to an uplink reference signal, such as a sounding reference signal (SRS). The reference signal may be associated with one or multiple UEs indicated by the configuration and/or signaling. In response to receiving the configuration and/or signaling, the NCR may apply the power offset when forwarding a downlink signal based on determining that a downlink beam applied for the forwarding is associated with an uplink beam associated with the indicated uplink reference signal. The association between the downlink beam and the uplink beam may be determined based on a beam correspondence indication and/or a channel reciprocity indication.

In another implementation, a beam may be indicated by an associated range of spatial directions. For example, if a gNB is informed of the location of the NCR and/or the cell boundary, it may indicate to the NCR to which directions to apply the power offset. The location may be provided by a TRP position information element (IE) (as specified, for example, in TS 38.455). The directions may be indicated by an angle with respect to a geographical direction (e.g., the North, 60 degrees from the North, etc.), an angle with respect to the line of sight between the gNB and the NCR, or the like. Alternatively, the directions may be indicated with respect to a direction that is computed with respect to the antenna plane (e.g., a direction orthogonal to the antenna plane). In one example, the gNB may indicate to the NCR to apply a power offset in the direction 180 degrees apart from the line of sight between the gNB and the NCR. This indication may intend to limit the transmission power towards the cell edge compared to the transmission power towards the center of the cell.

The range of directions may be indicated by a center angle (or antenna boresight angle) and an angular width, or alternatively, by two angles indicating the boundaries of the angular range. In response to receiving the configuration and/or signaling, the NCR may apply the power offset when forwarding a signal based on determining that a beam applied for the forwarding is in a direction within the indicated range of spatial directions. Additionally or alternatively, a beam may be indicated by a beam-width. In response to receiving the configuration and/or signaling, the NCR may apply the power offset when forwarding a signal based on determining that a beam applied for the forwarding has a beam-width the same as, or associated with, the indicated beam-width.

With respect to a plurality of power offsets, in some implementations, an NCR may receive one or multiple indications of power offset associated with one or multiple beams. In a special case, association between power offsets and beams may be one to one. In a more general case, one power offset may be associated with multiple beams, in which case, the NCR may apply the power offset for forwarding a signal based on determining that the any of the indicated beams are applied for the forwarding. In another general case, multiple power offsets may be associated with one beam. The NCR may then apply one of the power offsets based on a rule, such as to apply the highest power offset, apply the lowest power offset, apply the power offset that was received latest, or the like.

In yet another case, a maximum and/or a minimum power offset is indicated to the NCR in order to provide flexibility. In response, the NCR may apply a power offset that is not larger than the indicated maximum power offset and/or not smaller than the indicated minimum power offset. Similar methods or techniques may be adopted when an NCR receives one or multiple indications of power offset associated with one or multiple ranges of spatial directions. In some implementations, a set of pre-configured power offset values, or alternatively a codebook of power offset values, are defined. In one example, the codebook of power offset values includes power offset values that are evenly spaced in logarithmic domain (e.g., {0,1,2,3,4,5,6,7} dB).

With respect to semi-static signaling versus dynamic signaling, in an embodiment, the indication may be a semi-static configuration, for example by RRC or NG-RAN. This case is particularly useful for cell planning purposes when the network entities (gNB, NCR, etc.) are not mobile. In another implementation, the indication may be a dynamic control signaling, such as a DCI message or a MAC CE message. In this case, the power offset may be dynamically controlled by the gNB. This case may be more useful for mobile scenarios or for dynamic control of the interference when other gNBs in the vicinity may report inter-cell cross-link interference. In another implementation, a combination of semi-static and dynamic signaling is adopted. The NCR may first receive a semi-static configuration indicating a power offset associated with one or multiple beams. Then, a dynamic signaling may complement the information received by the indication, for example, modifying a power offset value or the association relationship between a power offset and one or multiple beams. In some examples, a dynamic signaling may override semi-static indications temporarily or persistently.

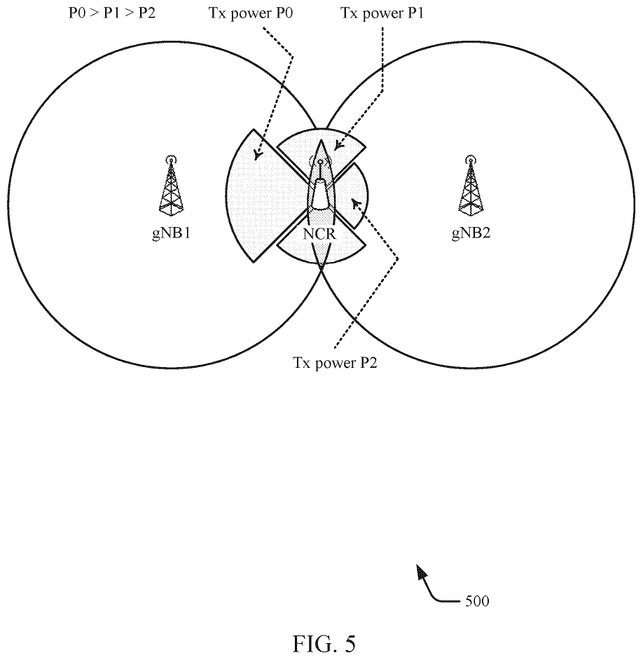

FIG. 5 illustrates an example 500 of reducing inter-cell interference by spatially associated power offset, as related to power control with NCRs in accordance with aspects of the present disclosure. The example 500 illustrates how applying a power offset associated with a beam or spatial direction may reduce interference in a neighbor cell. In the illustrated example, the NCR receives signals from gNB1 and forwards the signals served by gNB1 (i.e., in the cell illustrated on the left). In this example, beams that may cause a larger inter-cell interference are offset (reduced) by ratios P1/P0 and P2/P0 with respect to a reference power P0. This results in reduced inter-cell interference compared to the case that all signals are forwarded while applying the reference transmission power P0. It should be noted that the ratios may be described as subtractive (or additive) offsets in a logarithmic/decibel scale.

In an implementation for power adjustment, an NCR may receive a configuration and/or signaling from the network, where the configuration and/or signaling may include an indication to reduce or adjust transmission power in association with one or multiple beams. The power reduction may be indicated by value with respect to a current transmission power (e.g., in units of decibels (dB)). In an implementation, a beam may be indicated by a reference to a downlink reference signal such as a synchronization signal and physical broadcast channel (SS/PBCH) block, a channel state information reference signal (CSI-RS) or other downlink reference signals. The indication may include a reference signal (RS) identifier (ID), a quasi-collocation (QCL) relationship such as a QCL Type D with the reference signal as a source, a transmission configuration indication (TCI) comprising a QCL relationship, and the like. In response to receiving the configuration and/or signaling, the NCR may reduce or adjust the transmission power when forwarding the indicated reference signal. Additionally or alternatively, the NCR may reduce or adjust the transmission power when forwarding a downlink signal based on determining that a beam associated with the indicated reference signal is applied for the forwarding.

In another implementation, a beam may be indicated by a reference to an uplink reference signal, such as a sounding reference signal (SRS). The reference signal may be associated with one or multiple UEs indicated by the configuration and/or signaling. In response to receiving the configuration and/or signaling, the NCR may reduce or adjust the transmission power when forwarding a downlink signal based on determining that a downlink beam applied for the forwarding is associated with an uplink beam associated with the indicated uplink reference signal. The association between the downlink beam and the uplink beam may be determined based on a beam correspondence indication and/or a channel reciprocity indication.

In another implementation, a beam may be indicated by an associated range of spatial directions. For example, if a gNB is informed with the location of the NCR and/or the cell boundary, it may indicate to the NCR in which directions to apply the power offset if the NCR is deployed at a cell edge. If the NCR, is deployed within the cell to provide coverage for a low-coverage area, such as an outdoor-to-indoor scenario, a same or similar power offset may be applied for forwarding for all beams. The directions may be indicated by an angle with respect to a geographical direction (e.g., the North, 60 degrees from the North, etc.), an angle with respect to the line of sight between the gNB and the NCR, or the like. In one example, the gNB may indicate to the NCR to reduce or adjust the transmission power in the direction 180 degrees apart from the line of sight between the gNB and the NCR. This indication may intend to limit or adjust the transmission power towards the cell edge.

The range of directions may be indicated by a center angle in and an angular width, or alternatively, by two angles indicating the boundaries of the angular range. In response to receiving the configuration and/or signaling, the NCR may reduce or adjust the transmission power when forwarding a signal based on determining that a beam applied for the forwarding is in a direction within the indicated range of spatial directions. Additionally or alternatively, a beam may be indicated by a beam-width. In response to receiving the configuration and/or signaling, the NCR may reduce or adjust the transmission power when forwarding a signal based on determining that a beam applied for the forwarding has a beam-width the same as, or associated with, the indicated beam-width.

With respect to a plurality of power offsets, in implementations, an NCR may receive one or multiple indications of power reduction and/or adjustment associated with one or multiple beams. In a special case, association between power reduction and/or adjustment values and beams may be one to one. In a more general case, one power reduction or adjustment may be associated with multiple beams. Then, the NCR may reduce or adjust the transmission power for forwarding a signal based on determining that the any of the indicated beams are applied for the forwarding. In another general case, multiple power reduction and/or adjustment may be associated with one beam, in which case, the NCR may apply one of the power reduction and/or adjustment values based on a rule, such as to apply the highest power reduction and/or adjustment value, apply the lowest power reduction and/or adjustment value, apply the power reduction and/or adjustment value that was received latest, or the like. Similar methods or techniques may be adopted when an NCR receives one or multiple indications of power reduction and/or adjustment associated with one or multiple ranges of spatial directions.

With respect to semi-static signaling versus dynamic signaling, in an implementation, the indication may be a semi-static configuration, for example by RRC or NG-RAN. This case is particularly useful for cell planning purposes when the network entities (gNB, NCR, etc.) are not mobile. In another implementation, the indication may be a dynamic control signaling (e.g., a DCI message or a MAC CE message). In this case, the power reduction and/or adjustment may be dynamically controlled by the gNB. This case may be more useful for mobile scenarios or for dynamic control of the interference when other gNBs in the vicinity may report inter-cell cross-link interference. In another implementation, a combination of semi-static and dynamic signaling is adopted. The NCR may first receive a semi-static configuration indicating a power reduction and/or adjustment associated with one or multiple beams. Then, a dynamic signaling may complement the information received by the indication, for example modifying a transmission power or the association relationship between a transmission power and one or multiple beams. In some examples, a dynamic signaling may override semi-static indications temporarily or persistently.

Aspects of power control with NCRs take into account or consider an association with frequency and time. In implementations, a signaling to indicate a power offset and/or adjustment may be associated with a frequency. In an implementation, a power offset and/or adjustment is associated with a frequency band, sub-band, carrier, component carrier (CC), bandwidth part (BWP), a plurality of physical resource blocks (PRBs), a plurality of resource block groups (RBGs), or the like. In response to receiving the indication, the NCR may apply a power offset and/or adjustment when forwarding signals on the indicated frequency or range of frequencies. In the case that the NCR applies a frequency offset to the signal, the power offset and/or adjustment may be applied to signals received in the indicated frequency range, forwarded in the indicated frequency range, or a combination thereof. In some implementations, a signaling to indicate a power offset and/or adjustment may be associated with a time. In an implementation, a power offset and/or adjustment is associated with a time duration. In response, the NCR may apply the power offset and/or adjustment to signals received and/or forwarded during the time duration. Then, the NCR may apply a new power or adjustment based on new signaling, or may return to a transmission power indicated as a fallback or default if new signaling is not received.

In aspects of implementation, a timer may be configured or specified for the NCR that starts when a new power offset and/or adjustment is received. Once the timer expires, the NCR may apply a new power offset and/or adjustment, or a fallback or default power offset and/or adjustment. In another implementation, a power offset and/or adjustment is associated with a time duration that is periodic with a certain periodicity. In response, the NCR applies the power offset and/or adjustment to the signals received and/or forwarded during the time duration in each period. The NCR may apply a different power offset and/or adjustment, for example a default power offset and/or adjustment to signals received and/or forwarded outside the time duration in each period. In another implementation, an NCR may receive a plurality of power offset and/or adjustment indications associated with a plurality of time durations in a periodicity. In a special case, the association may be one to one. In response, the NCR may apply a first power offset and/or adjustment in a first time duration, a second power offset and/or adjustment in a second time duration, and so on in each period.

In these implementations, values of time duration and period or periodicity may be indicated, configured, or specified in units of slots, milliseconds, OFDM symbols, or the like. In the case of slots or OFDM symbols, values may be indicated in reference to a subcarrier spacing (SCS) or a numerology index. In some implementations, a power offset and/or adjustment may be associated with a channel or a signal. In an implementation, an NCR may receive an indication of a power offset and/or adjustment associated with a channel. The channel may be a control channel, such as a PDCCH or a PUCCH, or a shared or data channel, such as PDSCH or a PUSCH. In response, the NCR may apply the power offset and/or adjustment when forwarding signals associated with the channel. In an implementation, an NCR may receive an indication of a power offset and/or adjustment associated with a signal. The signal may be a reference signal such as an SS/PBCH block or a CSI-RS. In response, the NCR may apply the power offset and/or adjustment when forwarding the indicated signal. In some implementations, a power offset and/or adjustment may be associated with a channel type or a signal type. In an implementation, an NCR may receive an indication of a power offset and/or adjustment associated with a channel type. The channel may be a control channel, such as a PDCCH or a PUCCH, or a shared/data channel, such as PDSCH or a PUSCH as different channels may have different bandwidths and hence different interference levels at UEs. Furthermore, indicating power offset and/or adjustment of UL different than DL channels helps to avoid blocking the UL receiver at a gNB. In response, the NCR may apply the power offset and/or adjustment when forwarding signals associated with any channel of the indicated channel type.

In an implementation, an NCR may receive an indication of a power offset and/or adjustment associated with a signal type. The signal may be a reference signal such as an SS/PBCH block or a CSI-RS. In response, the NCR may apply the power offset and/or adjustment when forwarding any signals of the indicated signal type. In some embodiments, a power offset and/or adjustment may be indicated to exclude a channel, a channel type, a signal, or a signal type. In an implementation, an NCR may receive an indication of a power offset and/or adjustment that excludes a channel or a channel type. In response, the NCR may NOT apply the power offset and/or adjustment when forwarding signals associated with the indicated channel or channel type. This method may be particularly useful when it is desired to fix the transmission power for control channels at a constant transmission power value. In an implementation, an NCR may receive an indication of a power offset and/or adjustment associated with a signal or a signal type. In response, the NCR may NOT apply the power offset and/or adjustment when forwarding the indicated signal or signal type. This method may be particularly useful when it is desired to fix the transmission power for SS/PBCH blocks at a constant transmission power value.

In some implementations, a combination of the above methods or techniques may be adopted. For example, a power offset and/or adjustment indication may be associated with (or exclude) signals or channels in a frequency range and/or time duration. This may be in addition to association with one or multiple beams or directions as described above. In an implementation, the power offset is activated with a first triggering signal, where the power offset is applied within a first fixed or configured number of time slots of receiving the first triggering signal, such as the power offset is applied starting from a first slot or symbol relative to the slot or symbol of the received first triggering signal, and the power offset is applied for the first fixed or configured number of time slots. Additionally or alternatively, the power offset is deactivated (omitted, cancelled) with a second triggering signal, where the power offset is deactivated (omitted, cancelled) within a second fixed or configured number of time slots of receiving the second triggering signal. In some examples, the power offset is deactivated (omitted, cancelled, no-longer applied) starting from a second slot or symbol relative to the slot or symbol of the received second triggering signal.

Aspects of power control with NCRs take into account or consider collocation. In implementations, a power offset and/or adjustment indication may be applied to signal forwarding performed by any or all entities that are collocated. For example, if multiple NCRs and/or other network entities are physically collocated or otherwise indicated as collocated, a power offset and/or adjustment indication to one NCR or network entity may apply to any or all other collocated NCRs and/or network entities. In some implementations, a power offset and/or adjustment indication may be applied to all signals that share a common timing advance group (TAG).

Aspects of power control with NCRs take into account or consider a response to an interference report. In implementations, a gNB may transmit a power offset and/or adjustment signaling to an NCR in response to receiving an interference report from another cell in the vicinity. The signaling may be on an Xn interface (directly from another gNB) or on an NG interface (indirectly through a core network function such as an AMF). In one example, the interference report may be associated with a reference signal configured for interference management. Information of the reference signal may be shared with other cells in the vicinity. In another example, the interference report may be associated with a geographical area or a range of spatial directions.

Aspects of power control with NCRs take into account or consider other power constraints. In implementations, other power constraints may be considered when applying a power offset and/or adjustment. In one example, a minimum value of transmission power may be configured for the NCR. Then, the NCR may NOT apply a power offset and/or adjustment that results in the transmission power falling below the configured minimum value. Alternatively, the NCR may apply a power offset and/or adjustment only to the point that the transmission power does not fall below the configured minimum value. In either case, the NCR may transmit a report to the gNB indicating a conflict between the power offset and/or adjustment indication and the configured minimum value of transmission power. In another example, a maximum value of transmission power may be configured for the NCR, specified by the standard, or determined based on regulations. Then, the NCR may NOT apply a power offset and/or adjustment that results in the transmission power exceeding the maximum value. Alternatively, the NCR may apply a power offset and/or adjustment only to the point that the transmission power does not exceed the maximum value. In either case, the NCR may transmit a report to the gNB indicating a conflict between the power offset and/or adjustment indication and the maximum value of transmission power. In an implementation, the NCR is associated with a capability that is signaled to the network on whether the NCR can support different transmission powers. For an NCR that supports different transmission powers, further signaling of the range or values of the transmission power offset or variation that can be applied is signaled to the network.

With respect to amplify-and-forward (A&F) relaying performed by a repeater, including an NCR, different terms may be used in different contexts. It should be noted that these terms may be used interchangeably, and emphasis on using certain terms in this disclosure is not intended to limit the scope. Notably, repeating or relaying a signal by a repeater or relay may include receiving the signal, potentially processing the signal, and transmitting the potentially processed signal. The processing may include amplifying the signal, denoising the signal, and so on. According to the techniques described in this disclosure, the processing may include applying a frequency offset, also known as applying a frequency shift or shifting the frequency. Further, transmitting the potentially processed signal may also be referred to as forwarding the signal, hence the term amplify-and-forward. This term may not be used widely in the disclosure and, instead, the more generic term transmitting may be used.

Furthermore, despite emphasis on the terms repeater, analog repeater, RF repeater, amplify-and-forward (A&F) relay, and network-controlled repeater (NCR) in the disclosure, it should be noted that the aspects of power control with NCRs is not limited in scope to those devices, or devices that are referred to by those terms in specifications and implementation. For example, many implementations are applicable to other types of network nodes, such as digital repeaters, baseband repeaters, digital relays, decode-and-forward (D&F) relays, and the like. In particular, several of the describe implementations may be applied to the following examples: a repeater, such as an analog/RF repeater, without a network control channel, where a configuration of applying a frequency offset is provided by a pre-configuration on a hardware, software, firmware, or a combination thereof, accessible by the repeater; and a digital/D&F/baseband repeater with a network control channel, a pre-configuration on a hardware, software, firmware, or a combination thereof.

In aspects of the described implementations, the terms antenna, panel, and antenna panel are used interchangeably. An antenna panel may be a hardware that is used for transmitting and/or receiving radio signals at frequencies lower than 6 GHz, e.g., frequency range 1 (FR1), or higher than 6 GHz, e.g., frequency range 2 (FR2) or millimeter wave (mmWave). In some implementations, an antenna panel may include an array of antenna elements, where each antenna element is connected to hardware such as a phase shifter that allows a control module to apply spatial parameters for transmission and/or reception of signals. The resulting radiation pattern may be called a beam, which may or may not be unimodal and may allow the device (e.g., UE, node) to amplify signals that are transmitted or received from one or multiple spatial directions.

In some embodiments, an antenna panel may or may not be virtualized as an antenna port in the specifications. An antenna panel may be connected to a baseband processing module through a radio frequency (RF) chain for each of transmission (egress) and reception (ingress) directions. A capability of a device in terms of the number of antenna panels, their duplexing capabilities, their beamforming capabilities, and so on, may or may not be transparent to other devices. In some implementations, capability information may be communicated via signaling or, in some implementations, capability information may be provided to devices without a need for signaling. In the case that such information is available to other devices, such as a central unit (CU), it can be used for signaling or local decision making.

In some embodiments, an antenna panel may be a physical or logical antenna array comprising a set of antenna elements or antenna ports that share a common or a significant portion of an RF chain (e.g., in-phase/quadrature (I/Q) modulator, analog to digital (A/D) converter, local oscillator, phase shift network). The antenna panel may be a logical entity with physical antennas mapped to the logical entity. The mapping of physical antennas to the logical entity may be up to implementation. Communicating (receiving or transmitting) on at least a subset of antenna elements or antenna ports active for radiating energy (also referred to herein as active elements) of an antenna panel requires biasing or powering on of the RF chain which results in current drain or power consumption in the device (e.g., node) associated with the antenna panel (including power amplifier/low noise amplifier (LNA) power consumption associated with the antenna elements or antenna ports). The phrase “active for radiating energy,” as used herein, is not meant to be limited to a transmit function but also encompasses a receive function. Accordingly, an antenna element that is active for radiating energy may be coupled to a transmitter to transmit radio frequency energy or to a receiver to receive radio frequency energy, either simultaneously or sequentially, or may be coupled to a transceiver in general, for performing its intended functionality. Communicating on the active elements of an antenna panel enables generation of radiation patterns or beams.

In some implementations, and depending on the implementation, a panel can have at least one of the following functionalities as an operational role of a unit of antenna group to control its Tx beam independently, unit of antenna group to control its transmission power independently, unit of antenna group to control its transmission timing independently. The panel may be transparent to another node (e.g., next hop neighbour node). For certain condition(s), another node or network entity can assume the mapping between a device's physical antennas to the logical entity “panel” may not be changed. For example, the condition may include until the next update or report from the device, or include a duration of time over which the network entity assumes there will be no change to the mapping. A device may report its capability with respect to the panel to the network entity. The device capability may include at least the number of panels. In an implementation, the device may support transmission from one beam within a panel; with multiple panels, more than one beam (one beam per panel) may be used for transmission. In another implementation, more than one beam per panel may be supported or used for transmission.

In some of the described implementations, an antenna port is defined such that the channel over which a symbol on the antenna port is conveyed can be inferred from the channel over which another symbol on the same antenna port is conveyed. Two antenna ports are said to be quasi co-located (QCL) if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial Rx parameters. Two antenna ports may be quasi-located with respect to a subset of the large-scale properties and a different subset of large-scale properties may be indicated by a QCL Type. The QCL Type can indicate which channel properties are the same between the two reference signals (e.g., on the two antenna ports). Thus, the reference signals can be linked to each other with respect to what the device can assume about their channel statistics or QCL properties. For example, qcl-Type may take one of the following values. Other qcl-Types may be defined based on combination of one or large-scale properties: QCL-TypeA: {Doppler shift, Doppler spread, average delay, delay spread}; QCL-TypeB: {Doppler shift, Doppler spread}; QCL-TypeC: {Doppler shift, average delay}; and QCL-TypeD: {Spatial Rx parameter}.

Spatial receive (Rx) parameters may include one or more of: angle of arrival (AoA,) dominant AoA, average AoA, angular spread, power angular spectrum (PAS) of AoA, average AoD (angle of departure), PAS of AoD, transmit/receive channel correlation, transmit/receive beamforming, spatial channel correlation etc. The QCL-TypeA, QCL-TypeB, and QCL-TypeC may be applicable for all carrier frequencies, where the QCL-TypeD may be applicable only in higher carrier frequencies (e.g., mmWave, FR2 and beyond), and essentially the device may not be able to perform omni-directional transmission (i.e. the device would need to form beams for directional transmission). For a QCL-TypeD between two reference signals A and B, the reference signal A is considered to be spatially co-located with reference signal B and the device may assume that the reference signals A and B can be received with the same spatial filter (e.g., with the same RX beamforming weights).

An antenna port according to an embodiment may be a logical port that may correspond to a beam (resulting from beamforming) or may correspond to a physical antenna on a device. In some implementations, a physical antenna may map directly to a single antenna port, in which an antenna port corresponds to an actual physical antenna. Alternately, a set or subset of physical antennas, or antenna set or antenna array or antenna sub-array, may be mapped to one or more antenna ports after applying complex weights, a cyclic delay, or both, to the signal on each physical antenna. The physical antenna set may have antennas from a single module or panel or from multiple modules or panels. The weights may be fixed as in an antenna virtualization scheme, such as cyclic delay diversity (CDD). The procedure used to derive antenna ports from physical antennas may be specific to a device implementation and transparent to other devices.

In one or more of the described implementations, a TCI-state (transmission configuration indication) associated with a target transmission can indicate parameters for configuring a quasi-collocation relationship between the target transmission (e.g., target RS of DM-RS ports of the target transmission during a transmission occasion) and a source reference signal(s) (e.g., SSB/CSI-RS/SRS) with respect to quasi co-location type parameter(s) indicated in the corresponding TCI state. The TCI describes which reference signals are used as QCL source, and what QCL properties can be derived from each reference signal. A device can receive a configuration of a plurality of transmission configuration indicator states for a serving cell for transmissions on the serving cell (e.g., between a serving gNB and a smart repeater). In some implementations, a TCI state includes at least one source RS to provide a reference (device assumption) for determining QCL and/or spatial filter. In one or more of the implementations, an UL TCI state is provided if a device is configured with separate DL/UL TCI by RRC signaling. The UL TCI state may include a source reference signal which provides a reference for determining UL spatial domain transmission filter for the UL transmission (e.g., dynamic-grant/configured-grant based PUSCH, dedicated PUCCH resources) in a CC or across a set of configured CCs/BWPs.

In one or more implementations, a joint DL/UL TCI state is provided if the device is configured with joint DL/UL TCI by RRC signaling (e.g., configuration of joint TCI or separate DL/UL TCI is based on RRC signaling). The joint DL/UL TCI state refers to at least a common source reference RS used for determining both the DL QCL information and the UL spatial transmission filter. The source RS determined from the indicated joint (or common) TCI state provides QCL Type-D indication (e.g., for device-dedicated PDCCH/PDSCH) and is used to determine UL spatial transmission filter (e.g., for UE-dedicated PUSCH/PUCCH) for a CC or across a set of configured CCs/BWPs. In one example, the UL spatial transmission filter is derived from the RS of DL QCL Type D in the joint TCI state. The spatial setting of the UL transmission may be according to the spatial relation with a reference to the source RS configured with qcl-Type set to ‘typeD’ in the joint TCI state.

In one or more implementations, a spatial relation information associated with a target transmission can indicate parameters for configuring a spatial setting between the target transmission and a reference RS (e.g., SSB/CSI-RS/SRS). For example, the device may transmit the target transmission with the same spatial domain filter used for reception of the reference RS (e.g., DL RS such as SSB/CSI-RS). In another example, the device may transmit the target transmission with the same spatial domain transmission filter used for the transmission of the reference RS (e.g., UL RS such as SRS). A device can receive a configuration of a plurality of spatial relation information configurations for a serving cell for transmissions on the serving cell.

In one or more implementations, an UL TCI state is provided if a device is configured with separate DL/UL TCI by RRC signaling. The UL TCI state may include a source reference signal which provides a reference for determining an UL spatial domain transmission filter for the UL transmission (e.g., dynamic-grant/configured-grant based PUSCH, dedicated PUCCH resources) in a CC or across a set of configured CCs/BWPs. In some implementations, a joint DL/UL TCI state is provided if the device is configured with joint DL/UL TCI by RRC signaling (e.g., configuration of joint TCI or separate DL/UL TCI is based on RRC signaling). The joint DL/UL TCI state refers to at least a common source reference RS used for determining both the DL QCL information and the UL spatial transmission filter. The source RS determined from the indicated joint (or common) TCI state provides QCL Type-D indication (e.g., for device-dedicated PDCCH/PDSCH) and is used to determine an UL spatial transmission filter (e.g., for UE-dedicated PUSCH/PUCCH) for a CC or across a set of configured CCs/BWPs. In one example, the UL spatial transmission filter is derived from the RS of a DL QCL Type D in the joint TCI state. The spatial setting of the UL transmission may be according to the spatial relation with a reference to the source RS configured with qcl-Type set to ‘typeD’ in the joint TCI state.

In aspects of the disclosure for power control with NCRs, the following features may be noted. The different steps described for the example implementations, in the text and in the flowcharts, may be permuted. Each configuration may be provided by one or multiple configurations in practice. An earlier configuration may provide a subset of parameters while a later configuration may provide another subset of parameters. Alternatively, a later configuration may override values provided by an earlier configuration or a pre-configuration. A configuration may be provided by a radio resource control (RRC) signaling, a medium-access control (MAC) signaling, a physical layer signaling, such as a downlink control information (DCI) message, a combination thereof, or other methods. A configuration may include a pre-configuration or a semi-static configuration provided by the standard, by the vendor, and/or by the network/operator. Each parameter value received through configuration or indication may override previous values for a similar parameter.

Despite references to IAB, the proposed solutions may be applicable to wireless relay nodes and other types of wireless communication entities. The L1/L2 control signaling may refer to control signaling in layer 1 (physical layer) or layer 2 (data link layer). In particular, an L1/L2 control signaling may refer to an L1 control signaling such as a DCI message or a UCI message, an L2 control signaling such as a MAC message, or a combination thereof. A format and an interpretation of an L1/L2 control signaling may be determined by the standard, a configuration, other control signaling, or a combination thereof. Any parameter discussed in this disclosure may appear, in practice, as a linear function of that parameter in signaling or specifications. There may be techniques described in this disclosure to perform measurements for beam training on reference signals. Alternatively, in some implementations, a measurement may be performed on resources that are not necessarily configured for reference signals, but rather a node may measure a receive signal power and obtain a receive signal strength indicator (RSSI) or the like. In this disclosure, reference is made to beam indication. In practice, according to a standard specification, a beam indication may refer to an indication of a reference signal by an ID or indicator, a resource associated with a reference signal, a spatial relation information comprising information of a reference signal or a reciprocal of a reference signal (in the case of beam correspondence).

Although not exhaustive, abbreviations and acronyms used in this disclosure pertaining to aspects of power control with NCRs may include:
ACK Positive-Acknowledgement
A-CSI Aperiodic CSI
ACLR Adjacent Channel Leakage Ratio
AI Availability Indication
AMF Access and Mobility Management Function
BWP Bandwidth Part
CA Carrier Aggregation
CAI Conditional Availability Indication
CCCH SDU Common Control Channel Service Data Unit
CCE Control Channel Element
CG Cell Group
CG-PUSCH Configured Grant Physical Uplink Shared Channel
C-IA Conditionally Is Available
C-INA Conditionally Is Not Available
CRC Cyclic Redundancy Check
C-RNTI Cell RNTI
CSI Channel State Information
CSS Common Search Space
CCA Clear Channel Assessment
CORESET Control Resource Set
CP Cyclic Prefix
CU Central Unit
D Downlink
DFTS Discrete Fourier Transform Spread
DC Dual Connectivity/Dually Connected
DCI Downlink Control Information
DL Downlink
DL-RX Downlink Reception
DL-TX Downlink Transmission
DU Distributed Unit
eCCA Enhanced Clear Channel Assessment
eMBB Enhanced Mobile Broadband
eNB Evolved Node B
ETSI European Telecommunications Standards Institute
F Flexible (Resource)
FBE Frame Based Equipment
FD Full-Duplex
FDD Frequency Division Duplex
FDMA Frequency Division Multiple Access
FD-OCC Frequency Division Orthogonal Cover Code
GP Guard Period
H Hard (Resource)
HARQ-ACK Hybrid Automatic Repeat Request-Acknowledgement
HD Half-Duplex
IAB Integrated Access and Backhaul
IAB-CU Integrated Access and Backhaul Central Unit
IAB-DU Integrated Access and Backhaul Distributed Unit
IAB-MT Integrated Access and Backhaul Mobile Terminal
ID Identifier
IE Information Element
IoT Internet-of-Things
L1 Layer 1
L2 Layer 2
L3 Layer 3
LAA Licensed Assisted Access
LBE Load Based Equipment
LBT Listen-Before-Talk
LTE Long Term Evolution
MA Multiple Access
MAC Medium Access Control
MCG Master Cell Group
MCS Modulation and Coding Scheme
MIMO Multiple Input Multiple Output
MsgA Message A
MsgB Message B
MPO MsgA PUSCH Occasion
MPR Maximum Power Reduction
MPTR Multiple-Panel Transmission and Reception
MSG Master Cell Group
MT Mobile Terminal
MTC Machine Type Communication
MUSA Multi User Shared Access
NA Not Available (Resource), Unavailable (Resource)
NB Narrowband
NACK/NAK Negative-Acknowledgment
NCR Network-controlled repeater
gNB Next Generation Node B
NCR Network-controlled repeater
NOMA Non-Orthogonal Multiple Access
NUL Non-supplementary Uplink (e.g., a “normal” uplink carrier)
OFDM Orthogonal Frequency Division Multiplexing
OFDMA Orthogonal Frequency Division Multiple Access

PCell Primary Cell
PBCH Physical Broadcast Channel
PDU Protocol Data Unit
PDCCH Physical Downlink Control Channel
PDSCH Physical Downlink Shared Channel
PDMA Pattern Division Multiple Access
PHICH Physical Hybrid ARQ Indicator Channel
PRACH Physical Random Access Channel
PRB Physical Resource Block
PUCCH Physical Uplink Control Channel
PUSCH Physical Uplink Shared Channel
PHR Power Headroom Report
QCL Quasi Collocation
QoS Quality of Service
QPSK Quadrature Phase Shift Keying
RBG Resource Block Group
RRC Radio Resource Control
RACH Random Access Procedure
RAR Random Access Response
RNTI Radio Network Temporary Identifier
RRC Radio Resource Control
RRM Radio Resource Management
RS Reference Signal
RMSI Remaining Minimum System Information
RSRP Reference Signal Received Power
RSMA Resource Spread Multiple Access
RTT Round Trip Time
RX Receive
S Soft (Resource)
SCMA Sparse Code Multiple Access
SC-FDMA Single Carrier Frequency Division Multiple Access
SCell Secondary Cell
SCH Shared Channel
SCG Secondary Cell Group
SCS Subcarrier Spacing
SFI Slot Format Indication
SINR Signal-to-Interference-Plus-Noise Ratio
SIB System Information Block
SMTC SSB Measurement Timing Configuration
SpCell Special Cell (i.e. a PCell of a MCG or SCG)
SPS Semi-Persistent Scheduling
SS/PBCH Synchronization Signal/Physical Broadcast Channel
SR Scheduling Request
NCR Network-Controlled Repeater
SP-CSI Semi-persistent CSI
SRS Sounding Reference Signal
SRI SRS Resource Indicator
SSB Synchronization Signal Block
SS/PBCH Synchronization Signal and Physical Broadcast Channel
STC SSB Transmission Configuration
SUL Supplementary Uplink
TA Timing Advance
TB Transport block
TBS Transport Block Size
TCI Transmission Configuration Indicator
TC-RNTI Temporary Cell RNTI
TDD Time Division Duplex
TDM Time Division Multiplex
TD-OCC Time Division Orthogonal Cover Code
TEI Technical Enhancement and Improvement
TTI Transmission Time Interval
TX Transmit
U Uplink
UCI Uplink Control Information
UE User Entity/Equipment (Mobile Terminal)
UL Uplink
UL-RX Uplink Reception
UL-TX Uplink Transmission
URLLC Ultra-Reliable Low-Latency Communication
us, μs microsecond
USS UE-specific Search Space

Further, as used herein, “HARQ-ACK” may represent collectively the positive acknowledge (“ACK”) and the negative acknowledge (“NACK”). ACK means that a TB is correctly received while NACK (or NAK) means a TB is erroneously received.

Network-controlled repeaters (NCRs) extend the footprint and/or layout of cells in a cellular system for improving key performance indicators, such as throughput and coverage. As a result, the cells may extend well beyond their originally planned boundaries into adjacent cells, which may cause excessive interference if not properly planned. Particularly, if the NCRs close to the cell edge forward signals with a large transmission power towards inside and outside of the cell indiscriminately, the resulting inter-cell cross-link interference may exceed far above what was expected or planned without NCR operation. Techniques are proposed in this disclosure according to application of a power offset or adjustment applied to the signals that are forwarded towards the coverage area of neighbor cells. This leads to lowering the transmission power for signals that are more likely to cause inter-cell cross-link interference while avoiding compromising the coverage and signal quality for other UEs.

In one or more implementations, techniques are described in which an NCR receives a configuration and/or signaling from a base station, where the configuration and/or signaling includes an indication to apply a power offset and/or adjustment in an amplify-and-forward operation associated with one or multiple beams or spatial directions. In one or more implementations, the power offset and/or adjustment is associated with a frequency, time duration, channel, reference signal, or the like. In response, the NCR applies the power offset and/or adjustment when forwarding signals based on determining that the signals are associated with the indicated beams, spatial directions, frequency/time resources, channels, and/or reference signals.

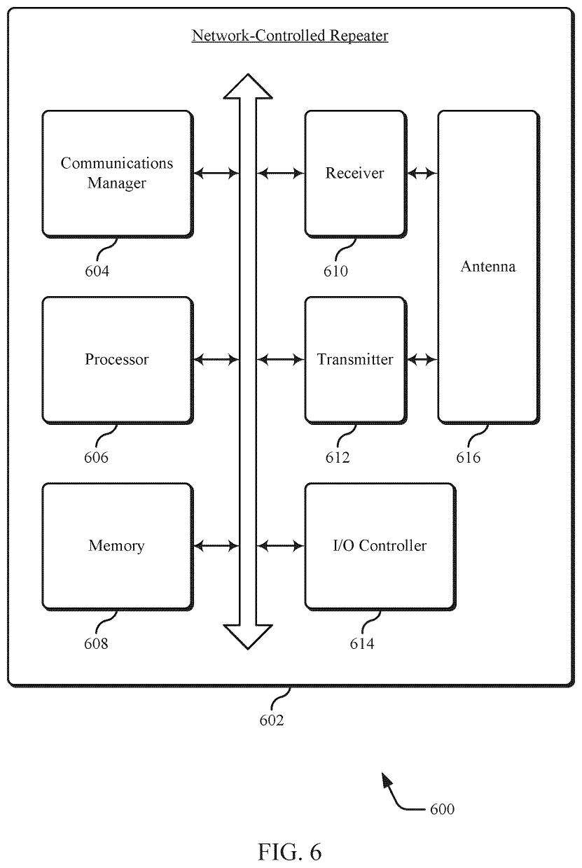

FIG. 6 illustrates an example of a block diagram 600 of a device 602 that supports power control with NCRs in accordance with aspects of the present disclosure. The device 602 may be an example of an NCR as described herein. The device 602 may support wireless communication and/or network signaling with one or more base stations 102, UEs 104, NCRs, network entities and devices, or any combination thereof. The device 602 may include components for bi-directional communications including components for transmitting and receiving communications, such as a communications manager 604, a processor 606, a memory 608, a receiver 610, a transmitter 612, and an I/O controller 614. These components may be in electronic communication or otherwise coupled (e.g., operatively, communicatively, functionally, electronically, electrically) via one or more interfaces (e.g., buses).

The communications manager 604, the receiver 610, the transmitter 612, or various combinations thereof or various components thereof may be examples of means for performing various aspects of the present disclosure as described herein. For example, the communications manager 604, the receiver 610, the transmitter 612, or various combinations or components thereof may support a method for performing one or more of the functions described herein.

In some implementations, the communications manager 604, the receiver 610, the transmitter 612, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 606 and the memory 608 coupled with the processor 606 may be configured to perform one or more of the functions described herein (e.g., by executing, by the processor 606, instructions stored in the memory 608).

Additionally or alternatively, in some implementations, the communications manager 604, the receiver 610, the transmitter 612, or various combinations or components thereof may be implemented in code (e.g., as communications management software or firmware) executed by the processor 606. If implemented in code executed by the processor 606, the functions of the communications manager 604, the receiver 610, the transmitter 612, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some implementations, the communications manager 604 may be configured to perform various operations (e.g., receiving, monitoring, transmitting) using or otherwise in cooperation with the receiver 610, the transmitter 612, or both. For example, the communications manager 604 may receive information from the receiver 610, send information to the transmitter 612, or be integrated in combination with the receiver 610, the transmitter 612, or both to receive information, transmit information, or perform various other operations as described herein. Although the communications manager 604 is illustrated as a separate component, in some implementations, one or more functions described with reference to the communications manager 604 may be supported by or performed by the processor 606, the memory 608, or any combination thereof. For example, the memory 608 may store code, which may include instructions executable by the processor 606 to cause the device 602 to perform various aspects of the present disclosure as described herein, or the processor 606 and the memory 608 may be otherwise configured to perform or support such operations.

For example, the communications manager 604 may support wireless communication and/or network signaling at a device (e.g., the device 602, an NCR) in accordance with examples as disclosed herein. The communications manager 604 and/or other device components may be configured as or otherwise support an apparatus, such as an NCR, including a transceiver; a processor coupled to the transceiver, the processor and the transceiver configured to cause the apparatus to: receive, from a base station, a first signal indicating a power offset value associated with one or more spatial filters; receive a second signal from the base station; determine whether a spatial filter that is to be applied to forward the second signal is included in the one or more spatial filters; and based at least in part on the spatial filter being included in the one or more spatial filters, transmit the second signal to a user equipment with the power offset value applied to adjust a reference transmission power.

Additionally, the apparatus (e.g., an NCR) includes any one or combination of: the apparatus is a network-controlled repeater. The first signal indicating a power offset value comprises an indication as at least one of a downlink control information (DCI) message, or a medium access control (MAC) control element (CE) message. The power offset value is indicated in decibels. Each of the one or more spatial filters are indicated by a reference to a downlink reference signal. The downlink reference signal is at least one of a synchronization signal and physical broadcast channel (SS/PBCH) block, or a channel state information reference signal (CSI-RS). The one or more spatial filters are indicated by a reference to an uplink reference signal. The downlink reference signal is a sounding reference signal (SRS). Each of the one or more spatial filters are indicated by a spatial direction. The apparatus configured to receive a third signal indicating the spatial filter that is to be applied to forward the second signal. The apparatus configured to receive a third signal indicating the user equipment and determine the spatial filter that is to be applied to forward the second signal is associated with the user equipment. The apparatus configured to determine the reference transmission power based in part on at least one of a capability of the apparatus, a configuration of the apparatus, a configuration from the base station, or a regional regulation. The reference transmission power is a default transmission power. The reference transmission power is a maximum transmission power associated with a cell provided by the base station. The power offset value is further associated with a frequency range; and the power offset value is further applied based at least in part on a determination that the second signal is in the frequency range. The power offset value is further associated with a time duration; and the power offset value is further applied based at least in part on a determination that the second signal is received during the time duration. The power offset value is further associated with at least one of a channel, a channel type, a reference signal, or a reference signal type; and the power offset value is further applied based at least in part on a determination that the second signal is associated with at least one of the channel, the channel type, the reference signal, or the reference signal type. The apparatus configured to determine that first signal indication is associated with a collocated wireless device.

Alternatively, or in addition, an apparatus (e.g., an NCR) includes a transceiver and a processor coupled to the transceiver, the processor and the transceiver configured to cause the apparatus to: receive, from a base station, a first message indicating a power offset value associated with one or more beam indicators; receive a first signal from the base station; determine whether a beam indicator that is to be applied to forward the first signal is included in the one or more beam indicators; and based at least in part on the beam indicator being included in the one or more beam indicators, transmit the first signal to a user equipment with the power offset value applied to adjust a reference transmission power.

Additionally, the apparatus includes any one or combination of: the apparatus is a network-controlled repeater. The first message indicating the power offset value includes at least one of a RRC configuration, a DCI message, or a MAC-CE message. The power offset value is indicated in decibels. Each of the one or more beam indicators are indicated by a reference to a downlink reference signal, and wherein the downlink reference signal is at least one of a SS/PBCH block, or a CSI-RS. Each of the one or more beam indicators are indicated by at least one of a spatial direction or a spatial filter. Each of the one or more beam indicators are indicated by an uplink reference signal, and the uplink reference signal is a SRS. The processor and the transceiver are configured to cause the apparatus to receive a second message indicating the beam indicator that is to be applied to forward the second signal. The processor and the transceiver are configured to cause the apparatus to receive a second message indicating the user equipment and determine the beam indicator that is to be applied to forward the first signal is associated with the user equipment. The processor and the transceiver are configured to cause the apparatus to determine the reference transmission power based in part on at least one of a capability of the apparatus, a configuration of the apparatus, the configuration from the base station, or a regional regulation. The reference transmission power is at least one of a default transmission power, or a maximum transmission power associated with a cell provided by the base station. The power offset value is further associated with a frequency range; and the power offset value is further applied based at least in part on a determination that the first signal is in the frequency range. The power offset value is further associated with a time duration; and the power offset value is further applied based at least in part on a determination that the first signal is received during the time duration. The power offset value is further associated with at least one of a channel, a channel type, a reference signal, or a reference signal type; and the power offset value is further applied based at least in part on a determination that the first signal is associated with at least one of the channel, the channel type, the reference signal, or the reference signal type. The processor and the transceiver are configured to cause the apparatus to determine that the first message is associated with a collocated wireless device.

Alternatively, or in addition, an apparatus (e.g., an NCR) includes a transceiver and a processor coupled to the transceiver, the processor and the transceiver configured to cause the apparatus to: receive, from a base station, a message indicating a power adjustment value associated with one or more beam indicators; receive a signal from the base station; determine whether a beam indicator that is to be applied to forward the signal is included in the one or more beam indicators; and based at least in part on the beam indicator being included in the one or more beam indicators, transmit the signal to a user equipment with the power adjustment value applied to adjust a previous transmission power.

Additionally, the apparatus (e.g., an NCR) includes any one or combination of: the power adjustment value is further associated with a frequency range; and the previous transmission power is associated with the frequency range. The power adjustment value is further associated with a time duration; and the previous transmission power is associated with the time duration. The power adjustment value is further associated with at least one of a channel, a channel type, a reference signal, or a reference signal type; and the previous transmission power is associated with the at least one of the channel, the channel type, the reference signal, or the reference signal type.

Alternatively, or in addition, a method of an apparatus (e.g., an NCR) includes receiving, from a base station, a message indicating at least one of a power offset value or a power adjustment value associated with one or more beam indicators; receiving a signal from the base station; determining whether a beam indicator that is to be applied to forward the signal is included in the one or more beam indicators; and transmitting the signal to a user equipment with at least one of the power offset value applied to adjust a reference transmission power, or the power adjustment value applied to adjust a previous transmission power.

The communications manager 604 and/or other device components may be configured as or otherwise support a means for wireless communication and/or network signaling at an NCR, including receiving, from a base station, a first signal indicating a power offset value associated with one or more spatial filters; receiving a second signal from the base station; determining whether a spatial filter that is to be applied to forward the second signal is included in the one or more spatial filters; and transmitting the second signal to a user equipment with the power offset value applied to adjust a reference transmission power.

Further, the communications manager 604 and/or other device components may be configured as or otherwise support an apparatus, such as a UE, including a transceiver; a processor coupled to the transceiver, the processor and the transceiver configured to cause the apparatus to: receive, from a base station, a first signal indicating a power adjustment value associated with one or more spatial filters; receive a second signal from the base station; determine whether a spatial filter that is to be applied to forward the second signal is included in the one or more spatial filters; and based at least in part on the spatial filter being included in the one or more spatial filters, transmit the second signal to a user equipment with the power adjustment value applied to adjust a previous transmission power.

Additionally, the apparatus (e.g., an NCR) includes any one or combination of: the power adjustment value is further associated with a frequency range; and the previous transmission power is associated with the frequency range. The power adjustment value is further associated with a time duration; and the previous transmission power is associated with the time duration. The power adjustment value is further associated with at least one of a channel, a channel type, a reference signal, or a reference signal type; and the previous transmission power is associated with at least one of the channel, the channel type, the reference signal, or the reference signal type.

The communications manager 604 and/or other device components may be configured as or otherwise support a means for wireless communication and/or network signaling at an NCR, including receiving, from a base station, a first signal indicating a power adjustment value associated with one or more spatial filters; receiving a second signal from the base station; determining whether a spatial filter that is to be applied to forward the second signal is included in the one or more spatial filters; and transmitting the second signal to a user equipment with the power adjustment value applied to adjust a previous transmission power.

The processor 606 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 606 may be configured to operate a memory array using a memory controller. In some other implementations, a memory controller may be integrated into the processor 606. The processor 606 may be configured to execute computer-readable instructions stored in a memory (e.g., the memory 608) to cause the device 602 to perform various functions of the present disclosure.

The memory 608 may include random access memory (RAM) and read-only memory (ROM). The memory 608 may store computer-readable, computer-executable code including instructions that, when executed by the processor 606 cause the device 602 to perform various functions described herein. The code may be stored in a non-transitory computer-readable medium such as system memory or another type of memory. In some implementations, the code may not be directly executable by the processor 606 but may cause a computer (e.g., when compiled and executed) to perform functions described herein. In some implementations, the memory 608 may include, among other things, a basic I/O system (BIOS) which may control basic hardware or software operation such as the interaction with peripheral components or devices.

The I/O controller 614 may manage input and output signals for the device 602. The I/O controller 614 may also manage peripherals not integrated into the device 602. In some implementations, the I/O controller 614 may represent a physical connection or port to an external peripheral. In some implementations, the I/O controller 614 may utilize an operating system such as iOS®, ANDROID®, MS-DOS®, MS-WINDOWS®, OS/2®, UNIX®, LINUX®, or another known operating system. In some implementations, the I/O controller 614 may be implemented as part of a processor, such as the processor 606. In some implementations, a user may interact with the device 602 via the I/O controller 614 or via hardware components controlled by the I/O controller 614.

In some implementations, the device 602 may include a single antenna 616. However, in some other implementations, the device 602 may have more than one antenna 616, which may be capable of concurrently transmitting or receiving multiple wireless transmissions. The receiver 610 and the transmitter 612 may communicate bi-directionally, via the one or more antennas 616, wired, or wireless links as described herein. For example, the receiver 610 and the transmitter 612 may represent a wireless transceiver and may communicate bi-directionally with another wireless transceiver. The transceiver may also include a modem to modulate the packets, to provide the modulated packets to one or more antennas 616 for transmission, and to demodulate packets received from the one or more antennas 616.

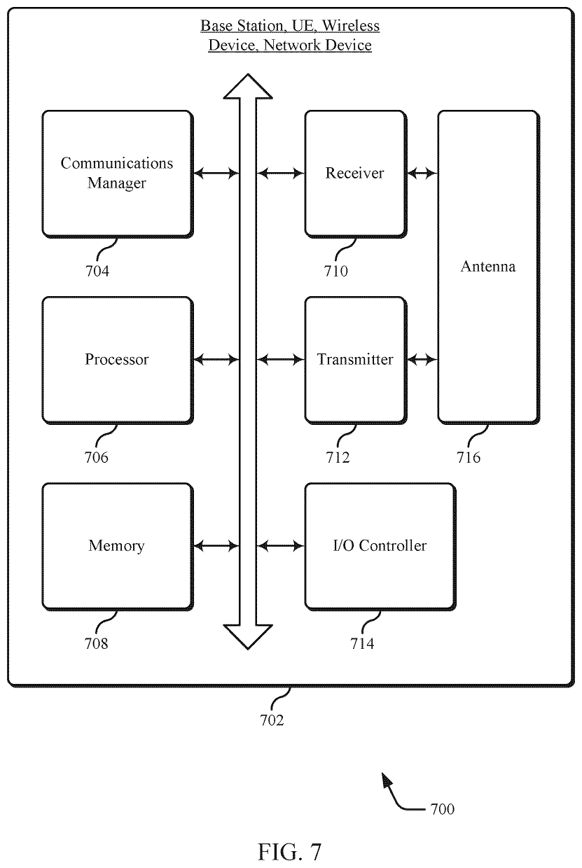

FIG. 7 illustrates an example of a block diagram 700 of a device 702 that supports power control with NCRs in accordance with aspects of the present disclosure. The device 702 may be an example of a base station 102 (e.g., a gNB), UE, wireless device, or any other network device as described herein. The device 702 may support wireless communication and/or network signaling with one or more base stations 102, other UEs 104, core network devices and functions (e.g., core network 106), or any combination thereof. The device 702 may include components for bi-directional communications including components for transmitting and receiving communications, such as a communications manager 704, a processor 706, a memory 708, a receiver 710, a transmitter 712, and an I/O controller 714. These components may be in electronic communication or otherwise coupled (e.g., operatively, communicatively, functionally, electronically, electrically) via one or more interfaces (e.g., buses).

The communications manager 704, the receiver 710, the transmitter 712, or various combinations thereof or various components thereof may be examples of means for performing various aspects of the present disclosure as described herein. For example, the communications manager 704, the receiver 710, the transmitter 712, or various combinations or components thereof may support a method for performing one or more of the functions described herein.

In some implementations, the communications manager 704, the receiver 710, the transmitter 712, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 706 and the memory 708 coupled with the processor 706 may be configured to perform one or more of the functions described herein (e.g., by executing, by the processor 706, instructions stored in the memory 708).

Additionally or alternatively, in some implementations, the communications manager 704, the receiver 710, the transmitter 712, or various combinations or components thereof may be implemented in code (e.g., as communications management software or firmware) executed by the processor 706. If implemented in code executed by the processor 706, the functions of the communications manager 704, the receiver 710, the transmitter 712, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some implementations, the communications manager 704 may be configured to perform various operations (e.g., receiving, monitoring, transmitting) using or otherwise in cooperation with the receiver 710, the transmitter 712, or both. For example, the communications manager 704 may receive information from the receiver 710, send information to the transmitter 712, or be integrated in combination with the receiver 710, the transmitter 712, or both to receive information, transmit information, or perform various other operations as described herein. Although the communications manager 704 is illustrated as a separate component, in some implementations, one or more functions described with reference to the communications manager 704 may be supported by or performed by the processor 706, the memory 708, or any combination thereof. For example, the memory 708 may store code, which may include instructions executable by the processor 706 to cause the device 702 to perform various aspects of the present disclosure as described herein, or the processor 706 and the memory 708 may be otherwise configured to perform or support such operations.

For example, the communications manager 704 may support wireless communication and/or network signaling at a device (e.g., the device 702, a base station 102, a gNB, UE 104, wireless device, or any other network device) in accordance with examples as disclosed herein. The communications manager 704 and/or other device components may be configured as or otherwise support an apparatus, such as a base station 102, a gNB, UE 104, wireless device, or any other network device.

The processor 706 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 706 may be configured to operate a memory array using a memory controller. In some other implementations, a memory controller may be integrated into the processor 706. The processor 706 may be configured to execute computer-readable instructions stored in a memory (e.g., the memory 708) to cause the device 702 to perform various functions of the present disclosure.

The memory 708 may include random access memory (RAM) and read-only memory (ROM). The memory 708 may store computer-readable, computer-executable code including instructions that, when executed by the processor 706 cause the device 702 to perform various functions described herein. The code may be stored in a non-transitory computer-readable medium such as system memory or another type of memory. In some implementations, the code may not be directly executable by the processor 706 but may cause a computer (e.g., when compiled and executed) to perform functions described herein. In some implementations, the memory 708 may include, among other things, a basic I/O system (BIOS) which may control basic hardware or software operation such as the interaction with peripheral components or devices.

The I/O controller 714 may manage input and output signals for the device 702. The I/O controller 714 may also manage peripherals not integrated into the device 702. In some implementations, the I/O controller 714 may represent a physical connection or port to an external peripheral. In some implementations, the I/O controller 714 may utilize an operating system such as iOS®, ANDROID®, MS-DOS®, MS-WINDOWS®, OS/2®, UNIX®, LINUX®, or another known operating system. In some implementations, the I/O controller 714 may be implemented as part of a processor, such as the processor 706. In some implementations, a user may interact with the device 702 via the I/O controller 714 or via hardware components controlled by the I/O controller 714.

In some implementations, the device 702 may include a single antenna 716. However, in some other implementations, the device 702 may have more than one antenna 716, which may be capable of concurrently transmitting or receiving multiple wireless transmissions. The receiver 710 and the transmitter 712 may communicate bi-directionally, via the one or more antennas 716, wired, or wireless links as described herein. For example, the receiver 710 and the transmitter 712 may represent a wireless transceiver and may communicate bi-directionally with another wireless transceiver. The transceiver may also include a modem to modulate the packets, to provide the modulated packets to one or more antennas 716 for transmission, and to demodulate packets received from the one or more antennas 716.

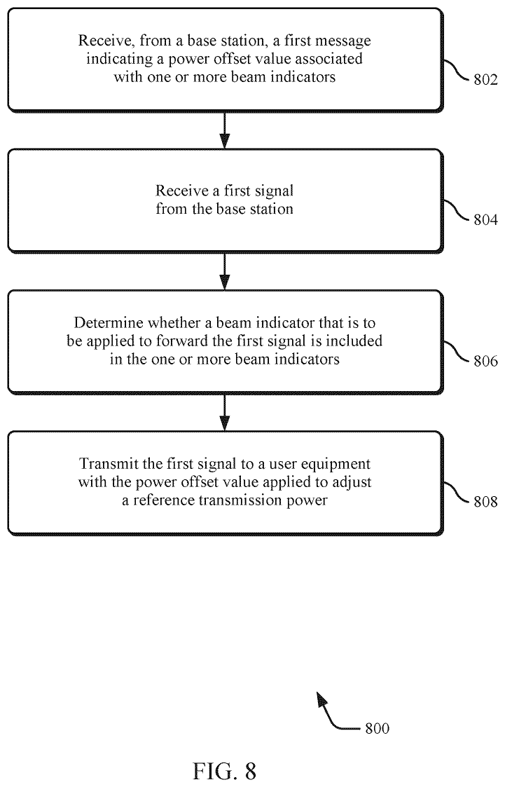

FIG. 8 illustrates a flowchart of a method 800 that supports power control with NCRs in accordance with aspects of the present disclosure. The operations of the method 800 may be implemented and performed by a device or its components, such as an NCR as described with reference to FIGS. 1 through 7. In some implementations, the device may execute a set of instructions to control the function elements of the device to perform the described functions. Additionally, or alternatively, the device may perform aspects of the described functions using special-purpose hardware.

At 802, the method may include receiving, from a base station, a first message indicating a power offset value associated with one or more beam indicators. The operations of 802 may be performed in accordance with examples as described herein. In some implementations, aspects of the operations of 802 may be performed by a device as described with reference to FIG. 1.

At 804, the method may include receiving a first signal from the base station. The operations of 804 may be performed in accordance with examples as described herein. In some implementations, aspects of the operations of 804 may be performed by a device as described with reference to FIG. 1.

At 806, the method may include determining whether a beam indicator that is to be applied to forward the first signal is included in the one or more beam indicators. The operations of 806 may be performed in accordance with examples as described herein. In some implementations, aspects of the operations of 806 may be performed by a device as described with reference to FIG. 1.

At 808, the method may include transmitting the first signal to a user equipment with the power offset value applied to adjust a reference transmission power. The operations of 808 may be performed in accordance with examples as described herein. In some implementations, aspects of the operations of 808 may be performed by a device as described with reference to FIG. 1.

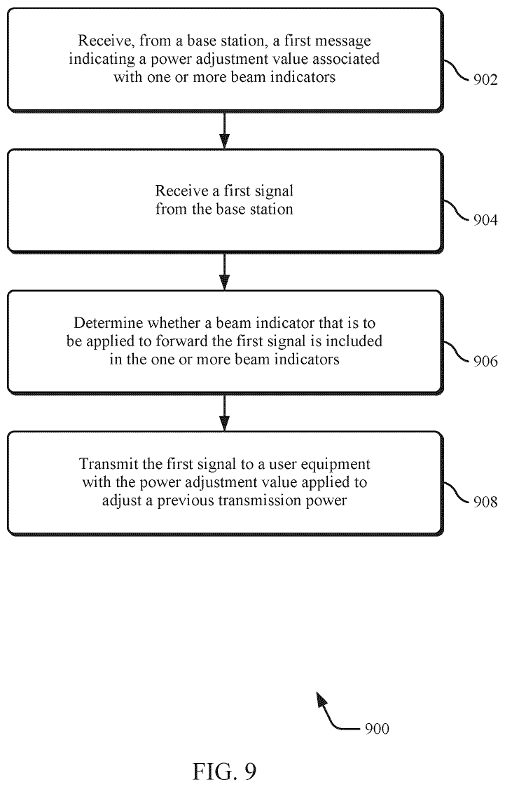

FIG. 9 illustrates a flowchart of a method 900 that supports power control with NCRs in accordance with aspects of the present disclosure. The operations of the method 900 may be implemented and performed by a device or its components, such as an NCR as described with reference to FIGS. 1 through 7. In some implementations, the device may execute a set of instructions to control the function elements of the device to perform the described functions. Additionally, or alternatively, the device may perform aspects of the described functions using special-purpose hardware.

At 902, the method may include receiving, from a base station, a first message indicating a power adjustment value associated with one or more beam indicators. The operations of 902 may be performed in accordance with examples as described herein. In some implementations, aspects of the operations of 902 may be performed by a device as described with reference to FIG. 1.

At 904, the method may include receiving a first signal from the base station. The operations of 904 may be performed in accordance with examples as described herein. In some implementations, aspects of the operations of 904 may be performed by a device as described with reference to FIG. 1.

At 906, the method may include determining whether a beam indicator that is to be applied to forward the first signal is included in the one or more beam indicators. The operations of 906 may be performed in accordance with examples as described herein. In some implementations, aspects of the operations of 906 may be performed by a device as described with reference to FIG. 1.

At 908, the method may include transmitting the first signal to a user equipment with the power adjustment value applied to adjust a previous transmission power. The operations of 908 may be performed in accordance with examples as described herein. In some implementations, aspects of the operations of 908 may be performed by a device as described with reference to FIG. 1.

It should be noted that the methods described herein describe possible implementations, and that the operations and the steps may be rearranged or otherwise modified and that other implementations are possible. Further, aspects from two or more of the methods may be combined. The order in which the methods are described is not intended to be construed as a limitation, and any number or combination of the described method operations may be performed in any order to perform a method, or an alternate method.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C, or AB or AC or BC, or ABC (i.e., A and B and C). Similarly, a list of one or more of A, B, or C means A or B or C, or AB or AC or BC, or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A network-controlled repeater (NCR) for wireless communication, comprising:
at least one memory; and
at least one processor coupled with the at least one memory and configured to cause the NCR to:
receive, from a base station, a first message indicating a power offset value associated with one or more beam indicators;
receive a first signal from the base station;
determine whether a beam indicator that is to be applied to forward the first signal is included in the one or more beam indicators; and
based at least in part on the beam indicator being included in the one or more beam indicators, transmit the first signal to a user equipment with the power offset value applied to adjust a reference transmission power.

2. (canceled)

3. The NCR of claim 1, wherein the first message indicating the power offset value includes at least one of a radio resource control (RRC) configuration, a downlink control information (DCI) message, or a medium access control (MAC) control element (CE) message.

4. The NCR of claim 1, wherein the power offset value is indicated in decibels.

5. The NCR of claim 1, wherein each of the one or more beam indicators are indicated by a reference to a downlink reference signal, and wherein the downlink reference signal is at least one of a synchronization signal and physical broadcast channel (SS/PBCH) block, or a channel state information reference signal (CSI-RS).

6. The NCR of claim 1, wherein each of the one or more beam indicators are indicated by at least one of a spatial direction or a spatial filter.

7. The NCR of claim 1, wherein each of the one or more beam indicators are indicated by an uplink reference signal, and the uplink reference signal is a sounding reference signal (SRS).

8. The NCR of claim 1, wherein the at least one processor is configured to cause the NCR to receive a second message indicating the beam indicator that is to be applied to forward the first signal.

9. The NCR of claim 1, wherein the at least one processor is configured to cause the NCR to receive a second message indicating the user equipment and determine the beam indicator that is to be applied to forward the first signal is associated with the user equipment.

10. The NCR of claim 1, wherein the at least one processor is configured to cause the NCR to determine the reference transmission power based in part on at least one of a capability of the NCR, a configuration of the NCR, the configuration from the base station, or a regional regulation.

11. The NCR of claim 1, wherein the reference transmission power is at least one of a default transmission power, or a maximum transmission power associated with a cell provided by the base station.

12. The NCR of claim 1, wherein:
the power offset value is further associated with a frequency range; and
the power offset value is further applied based at least in part on a determination that the first signal is in the frequency range.

13. The NCR of claim 1, wherein:
the power offset value is further associated with a time duration; and
the power offset value is further applied based at least in part on a determination that the first signal is received during the time duration.

14. The NCR of claim 1, wherein:
the power offset value is further associated with at least one of a channel, a channel type, a reference signal, or a reference signal type; and
the power offset value is further applied based at least in part on a determination that the first signal is associated with at least one of the channel, the channel type, the reference signal, or the reference signal type.

15. The NCR of claim 1, wherein the at least one processor is configured to cause the NCR to cause the NCR to determine that the first message is associated with a collocated wireless device.

16. A network-controlled repeater (NCR) for wireless communication, comprising:
at least one memory; and
at least one processor coupled with the at least one memory and configured to cause the apparatus NCR to:
receive, from a base station, a message indicating a power adjustment value associated with one or more beam indicators;
receive a signal from the base station;
determine whether a beam indicator that is to be applied to forward the signal is included in the one or more beam indicators; and
based at least in part on the beam indicator being included in the one or more beam indicators, transmit the signal to a user equipment with the power adjustment value applied to adjust a previous transmission power.

17. The NCR of claim 16, wherein:
the power adjustment value is further associated with a frequency range; and
the previous transmission power is associated with the frequency range.

18. The NCR of claim 16, wherein:
the power adjustment value is further associated with a time duration; and
the previous transmission power is associated with the time duration.

19. The NCR of claim 16, wherein:
the power adjustment value is further associated with at least one of a channel, a channel type, a reference signal, or a reference signal type; and
the previous transmission power is associated with the at least one of the channel, the channel type, the reference signal, or the reference signal type.

20. A method performed by a network-controlled repeater (NCR), the method comprising:
receiving, from a base station, a message indicating at least one of a power offset value or a power adjustment value associated with one or more beam indicators;
receiving a signal from the base station;
determining whether a beam indicator that is to be applied to forward the signal is included in the one or more beam indicators; and
transmitting the signal to a user equipment with at least one of the power offset value applied to adjust a reference transmission power, or the power adjustment value applied to adjust a previous transmission power.

21. A processor for wireless communication, comprising:
at least one controller coupled with at least one memory and configured to cause the processor to:
receive, from a base station, a first message indicating a power offset value associated with one or more beam indicators;
receive a first signal from the base station;
determine whether a beam indicator that is to be applied to forward the first signal is included in the one or more beam indicators; and
based at least in part on the beam indicator being included in the one or more beam indicators, transmit the first signal to a user equipment with the power offset value applied to adjust a reference transmission power.
